(19) United States
(12) Patent Application Publication
(10) Pub. No.: US 2025/0199810 A1
(43) Pub. Date: Jun. 19, 2025

(54) AUTOBATCH BUFFERS FOR PARALLEL PROCESSING SYSTEMS

(71) Applicant: NVIDIA Corporation, Santa Clara, CA (US)

(72) Inventors: Zaid Qureshi, New York, NY (US); Isaac Gelado, Pacifica, CA (US)

(21) Appl. No.: 18/663,840

(22) Filed: May 14, 2024

Related U.S. Application Data
(60) Provisional application No. 63/610,874, filed on Dec. 15, 2023.

(51) Int. Cl. G06F 9/30; G06F 9/32; G06F 9/48

(52) U.S. Cl. CPC G06F 9/3009; G06F 9/321; G06F 9/4856

(57) ABSTRACT

In managing a multiple threaded processing system, it can be difficult to store and commit each thread. To reduce the computing resources needed to manage the multiple threads, a linear autobatch buffer process can be utilized. As thread requests are received, an appropriate autobatch buffer can be identified. If the autobatch buffer is full, an increment can be used to select a different autobatch buffer as the active buffer. Once each thread in the autobatch buffer are committed and completed, the buffer can be retired. One thread in the buffer is designated the control thread and is responsible for controlling and retiring the buffer so that the other threads do not expend resources checking on the buffer status.

### CROSS-REFERENCE TO RELATED APPLICATION

This application claims the benefit of U.S. Provisional Application Ser. No. 63/610,874 filed Dec. 15, 2023, by Zaid Qureshi, et al., entitled “AUTOBATCH BUFFERS FOR PARALLEL PROCESSING SYSTEMS,” commonly assigned with this application and incorporated herein by reference in its entirety.

### TECHNICAL FIELD

This application is directed, in general, to handling parallel processing requests and, more specifically, to directing the operation of request threads.

### BACKGROUND

In computer processing systems, there is a need to be able to process multiple threads of execution in parallel, partially in parallel, overlapping, serially, partially in serial and parallel, or various combinations thereof, depending on the resources required and the processing time to complete each thread request. As the number of thread requests increases, managing the thread requests becomes more difficult and additional system resources (such as memory) are needed to perform the management tasks. The number of management operations also increase, which can cause a decrease in the processor time available as the processor needs to handle the management operations. It would be beneficial to have a thread request management system that can reduce the memory needed to maintain the thread management operation and reduce the amount of processor operations needed to maintain the thread management operation.

### SUMMARY

In one aspect, a method to batch process more than one thread request as a set of thread requests is disclosed. In one embodiment, the method includes (1) receiving the set of thread requests within an epoch, wherein the set of thread requests comprise instructions to a processing system to execute code, (2) storing the set of thread requests in an autobatch buffer, wherein the autobatch buffer is a linear buffer, (3) submitting contents of the autobatch buffer in one operation, wherein one thread request in the autobatch buffer is designated a control thread, and the set of thread requests in the autobatch buffer execute a set of atomic operations, and (4) retiring the autobatch buffer at a time the control thread indicates.

In a second aspect, a system is disclosed. In one embodiment, the system includes (1) a receiver, operational to receive thread requests, wherein the thread requests are requests to a processing system to execute code, and (2) one or more processors, operational to execute the thread requests using parallel processing across one or more cores, processors, or streaming processors, wherein the thread requests are stored in one or more linear autobatch buffers, each autobatch buffer submits its thread requests in one operation, one thread request in each autobatch buffer is designated a control thread, non-control thread requests in each autobatch buffer execute a set of atomic operations, and retire each autobatch buffer at a time the control thread within each respective autobatch buffer so indicates.

In a third aspect, a computer program product having a series of operating instructions stored on a non-transitory computer-readable medium that directs a data processing apparatus when executed thereby to perform operations to batch process more than one thread request as a set of thread requests is disclosed. In one embodiment, the operations include (1) receiving the set of thread requests within an epoch, wherein the set of thread requests comprise instructions to a processing system to execute code, (2) storing the set of thread requests in an autobatch buffer, wherein the autobatch buffer is a linear buffer, (3) submitting contents of the autobatch buffer in one operation, wherein one thread request in the autobatch buffer is designated a control thread, and the set of thread requests in the autobatch buffer execute a set of atomic operations, and (4) retiring the autobatch buffer at a time the control thread indicates.

### BRIEF DESCRIPTION

Reference is now made to the following descriptions taken in conjunction with the accompanying drawings, in which:

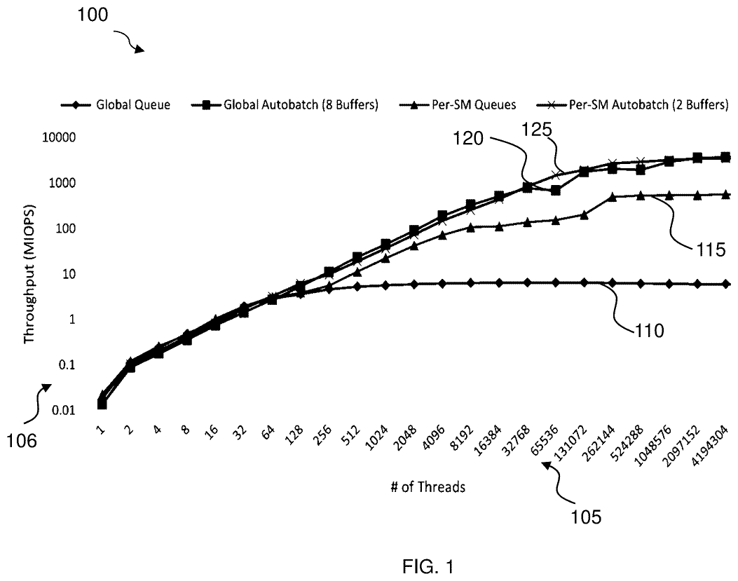

FIG. 1 is an illustration of a diagram of an example chart showing the throughput of various processes;

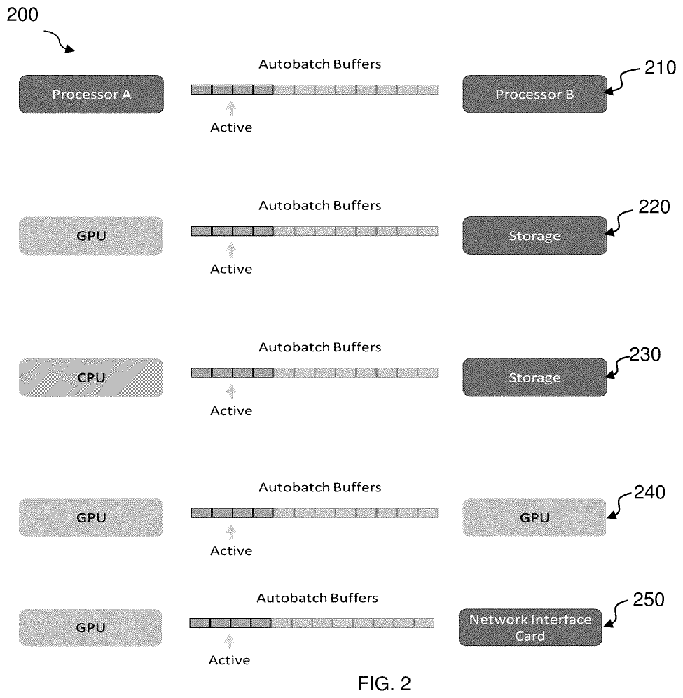

FIG. 2 is an illustration of diagrams of example autobatch buffer systems;

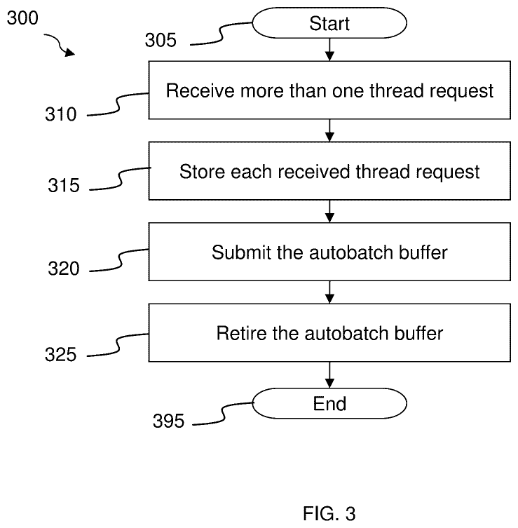

FIG. 3 is an illustration of a flow diagram of an example method for utilizing batch processes;

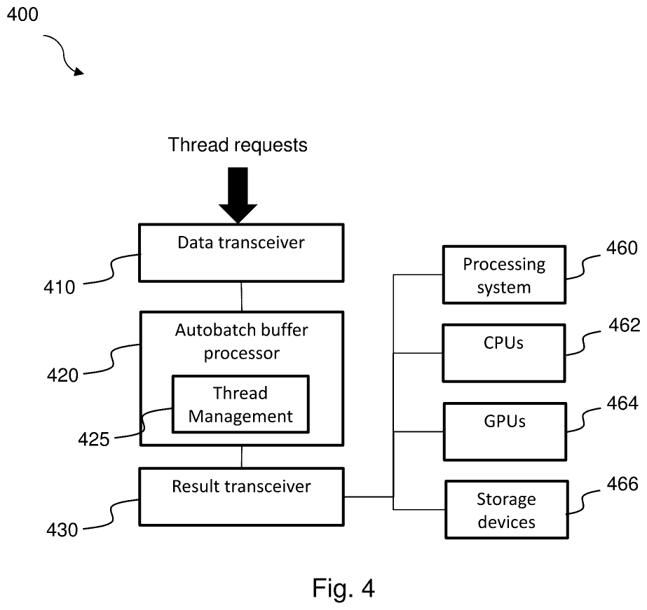

FIG. 4 is an illustration of a block diagram of an example autobatch buffer system; and

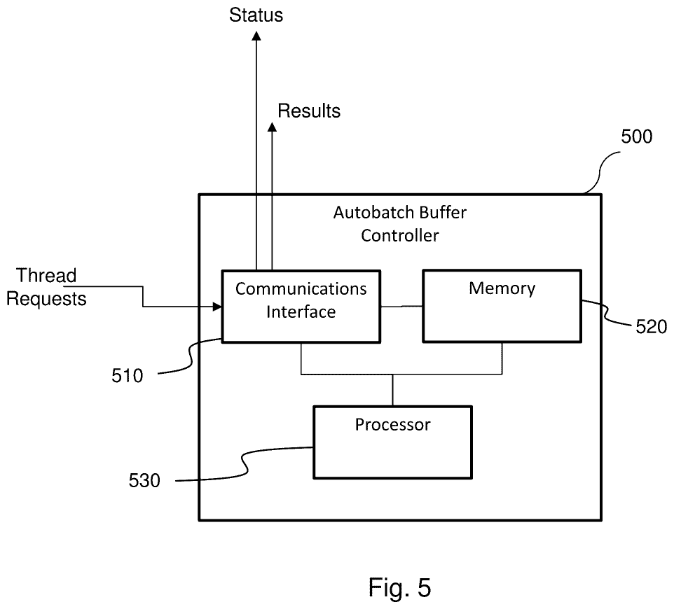

FIG. 5 is an illustration of a block diagram of an example of an autobatch buffer controller according to the principles of the disclosure.

### DETAILED DESCRIPTION

In computer processing of an application, multiple requests can be submitted to the processing system, where each request is a portion of work or a task. These tasks, or a portion thereof, can often be performed independently of each other. Being able to process these tasks in a non-serial fashion can greatly reduce the time it takes to complete the whole set of tasks. Parallel processing can be used to enhance the speed of performing the requested computations or actions. Parallel processing includes any variation that is not strictly serial processing, which includes staggered start times, overlapping execution, and other non-strictly serial processing of work tasks. Processing systems have developed a processing system of threads, where each thread is capable of carrying out the work components indicated by a respective task.

Processing systems can include one or more multiple-core processors, one or more processors, or a combination thereof. Processors include various types of processors, for example, central processing units (CPUs), graphic processing units (GPUs), single instruction/multiple data (SIMD) processors, or other processor types. Each of the processor types can be capable of executing more than one thread at a time. Managing the threads as each one starts, executes, and completes can become complex as the number of threads increases, especially as new threads are being established while older threads remain actively executing the desired functionality. Conventional work request submission mechanisms to handle multiple threads of execution, such as submission queues, may not scale with the number of concurrent threads attempting to submit work to an external entity, for example, a network interface card (NIC), a remote server, using a storage device such as a nonvolatile memory express (NVMe) solid-state drive (SSD) system, or other types of entities external to the processing system.

Mitigation strategies can be used, such as creating multiple submission queues and statically assigning them to different groups of threads. These conventional strategies tend to require a large number of resources (such as memory) and can face scalability problems as the number of concurrent threads increases.

In the present disclosure, processes can be determined to concurrently submit work requests to one submission structure to better handle a large number of threads using fewer system resources than conventional processes. The processes can avoid serialization across threads, which can be the scalability limiting factor of conventional approaches. In some aspects, the disclosed processes can automatically form batches of work requests that can be submitted in one operation, which can reduce the number of interactions with external entities, such as input/output (I/O) devices. In some aspects, the processes can provide a method for submitting threads that can selectively wait on one memory location for a response.

The disclosed processes, for example, do not rely on software circular queues. In some aspects, the processes include a process that utilizes an array of linear buffers whose contents are submitted in one operation. This new process enables a submission algorithm that can execute a fixed number of atomic operations without needing to poll for the updates of previous threads in the batch. The fixed number of atomic operations can be: (1) increase the ‘in’ counter of the buffer, (2) increase the resend count of the thread, (3) increase the ‘out’ counter of the buffer, and (4) adjust the count of the buffer. The processes can use these atomic operations to manage the buffer, which in turn manages the threads assigned to this buffer.

Specifically, the disclosed processes can be the high throughput work submission mechanism used by various processing systems. An autobatch buffer process can include a batching control and a set of thread request buffers. The batching control can track which buffer new thread requests are stored into, and when a batch of thread request entries is ready for submission. The set of work request buffers enables the concurrent formation and submission of multiple thread request entry buffers.

Pseudocode, such as [in-counter], [out-counter], [epoch-counter], [buffer.in-counter], and [buffer.out-counter] are utilized as examples to assist in explaining the disclosure. An implementation can utilize various computing languages or structures, for example, using arrays, collections, lists, sets, or other data structures. The functionality represented by the pseudocode is part of the disclosed processes regardless of the names or labels used in the implementation of the processes.

The data structures used can be described as follows. The autobatch buffer processes can include two counters as part of the atomic operations, [epoch-counter] and [in-counter], and an array of [out-counter], with as many elements as buffers in the autobatch. The [in-counter] tracks the number of thread requests that have entered the current epoch, as well as the current epoch value. Epoch herein refers to a time range. The [epoch-counter] tracks the epoch number ready to be advanced. Each counter in the [out-counter] array tracks the number of thread requests that have exited the epoch assigned to each thread request buffer.

Each thread request buffer can include a set of thread request entries laid out contiguously in the virtual address space, and two atomic counters: [buffer.in-counter] and [buffer.out-counter]. [buffer.in] can track the number of entries allocated within the buffer. [buffer.out-counter] can track the number of entries with valid contents within the buffer.

The epoch tracking can be described as follows. The autobatch relies on epochs to form batches of thread requests. Each epoch value has an associated thread request buffer: the value of the epoch modulo the number of buffers in the autobatch can be used to determine the buffer in the set of buffers (e.g., a tray of buffers).

The [in-counter] can track the current epoch value in its highest-order bits. The number of bits used for the epoch value can depend on the number of thread request buffers. The remaining bits in the [in-counter] can track the number of threads that have entered the epoch in the highest-order bits.

The epoch value encoded in the [in-counter] determines the active autobatch buffer, i.e., the thread request buffer where a thread entering the epoch will submit a thread request. Advancing, e.g., incrementing, the epoch switches the active autobatch buffer, and requires setting the next epoch value (e.g., subsequent epoch) and resetting the epoch count in the [in-counter]. The active autobatch buffer switched to becomes the new autobatch buffer to be used for subsequent received thread requests or set of thread requests.

Acquiring a work request entry can be described as follows. Active autobatch buffer acquisition is the process by which a thread can get a reference to a thread request entry in the active autobatch buffer, ensuring the validity of the acquired entry until actively released by the acquiring thread. This process can start by obtaining the current epoch by atomically incrementing the [in-counter] and reading the higher-order bits of the return value to obtain the assigned epoch.

The thread can use the epoch value to first index the thread request buffer array to obtain the active autobatch buffer, and can then atomically increment its [buffer.in-counter]. The return value of this atomic increment can return the index within the buffer assigned to the thread. The thread can use the assigned epoch value to index the [out-counter] array, and atomically increment its value.

In some aspects, the returned buffer index value might be greater than the number of entries in the buffer. The thread can check this condition after the atomic increment of the epoch's [out-counter], and if it detects an acquisition failure, the thread can initiate a re-attempt. This re-attempt can start by trying to bump the current epoch value and, thus, selecting a new active autobatch buffer that might have available thread request entries. The thread might fail to advance the epoch value because other concurrent threads have already advanced it. Hence, whether the epoch advance operation succeeds or fails, the thread can re-attempt to acquire an entry in the active autobatch buffer as previously described. In some aspects, a check can be made if the epoch value has changed after incrementing the [in-counter], and an attempt to acquire a thread request entry is made if this value is different from the epoch value on the previous attempt.

The validating of thread request entries can be described as follows. Threads can advance the epoch from a known value, i.e., the advance epoch operation can require the calling thread to provide the latest epoch value observed. A condition to advance the epoch can be that the active autobatch buffer contains allocated or valid entries. The processes attempt to advance the epoch when a thread has validated a thread request entry or when a thread fails to acquire a thread request entry due to the active autobatch buffer being fully used.

A second condition used to advance the epoch can be that the thread request buffer that the new epoch value would set as the active autobatch buffer is available. To check the availability of the active autobatch buffer, the thread can inspect the [buffer.in-counter] of the target buffer and ensure its value is zero. A concurrent thread can update the [buffer.in-counter] after this check completes. Such a case can happen if that thread or another concurrent thread has successfully advanced the epoch, which would then abort this operation.

A third condition used to advance the epoch can be that the current epoch value matches the provided starting epoch value. To ensure this condition is met, the thread can update the [epoch-counter] using an atomic compare and swap operation. If this atomic operation fails to update the [epoch-counter], for example, a concurrent thread has already advanced the epoch, the thread can abort the operation. After successfully updating the [epoch-counter], the thread can make the new epoch value available by setting its value on the [in-counter] using an atomic exchange operation. This operation can set the count to zero if the thread is advancing the epoch after validating a thread request entry, or to one if the thread is advancing the epoch to re-attempt acquiring a thread request entry.

The thread request buffer commit process can be described as follows. The commit operation can send the valid entries of the autobatch buffer as a batch in one submit operation. For the autobatch buffer to be ready for a commit, two conditions should be satisfied, (1) the autobatch buffer is not longer than the active buffer, and (2) no threads are updating a thread request entry in the buffer.

An autobatch buffer is not the active autobatch buffer as long as the epoch value does not index it as active. For example, the epoch value modulo the number of autobatch buffers in the autobatch is different from the index of the autobatch buffer in the set of thread request buffers. Rather than checking for this condition, the processes can attempt to commit an autobatch buffer after successfully advancing the epoch that selected it as an active autobatch buffer. The epoch advance process can prevent an autobatch buffer from becoming active if it is otherwise in use. In some aspects, the autobatch buffer cannot become active until the commit operation resets its [buffer.in-counter] and [buffer.out-counter].

The commit process can rely on the prior successful epoch advance operation to ensure that no thread is updating the entries within the autobatch buffer. In some aspects, when a thread attempts to acquire an entry in the active autobatch buffer after the epoch was advanced, the thread can observe an updated epoch value that cannot select the autobatch buffer as the active autobatch buffer because the advance epoch operation incremented the epoch value, effectively deactivating the autobatch buffer. No further epoch advance operation can reactive the autobatch buffer since it is still in use by other thread requests.

In some aspects, when a thread attempts to acquire an entry concurrently with the advance epoch operation, the thread can observe the epoch value before or after the advance epoch operation updates its contents. If the thread observes the value after the epoch update, the above aspect can be followed. When the thread observes the epoch value before the update, the commit process can wait for that thread to complete acquiring and validating the thread request entry in the autobatch buffer.

The advance epoch operation can return the value of the [in-counter] at the time it advanced the epoch. In some aspects, this process can read the [in-counter] and can advance the epoch value in one atomic operation. In some aspects, the thread request entry acquisition process can increment the [in-counter] and read the current epoch value in one atomic operation. The atomicity of the operations can improve the operation so that a thread observing the epoch being committed as current can also increment the [in-counter]. This update can be observed by the advance epoch process. Since the thread request entry acquisition process can increment the [buffer.in-counter] before incrementing the [epoch-counter] in the [out-counter] array, once the epoch entry in the [out-counter] array reaches the value returned by the advance epoch process, no further updates to the [buffer.in-counter] are possible. The thread entry acquisition process can update the [buffer.out-counter] after the contents of the acquired entry are valid.

The processes utilize these mechanisms to wait for the thread entries in the thread request buffer that is being committed to first become valid. The commit process can wait for the epoch entry in the [out-counter] to reach the value returned by the advance epoch process. This wait ensures that no additional threads can acquire an entry in the autobatch buffer (i.e., [buffer.in-counter] can remain constant). The process then can wait for the threads currently updating thread request entries in the autobatch buffer to complete, i.e., the value of the [buffer.out-counter] becoming equal to the [buffer.in-counter].

One of the conditions to advance the epoch value can be that the autobatch buffer is selected as active after the update is available. Since the active buffer cannot be committed, it can be possible that none of the threads filling thread request entries in the active autobatch buffer is capable of retiring the autobatch buffer. A polling approach to wait for the epoch to advance (as used in conventional thread management systems) involves a large number of threads flooding the memory subsystem and, thus, can cause an overall system slowdown. The disclosed processes use a deferred thread request autobatch buffer commit approach to decrease the memory needs of the thread management process.

Upon successfully committing an autobatch buffer and waiting for this autobatch buffer to become available (e.g., a server acknowledging the operation), the commit process can check if the autobatch buffer whose epoch advance operation would set the just committed buffer as active (i.e., the autobatch buffer at the previous index) has reserved or valid entries (i.e., the [buffer.in-counter] or [buffer.out-counter] are different from zero). In some aspects, the process can commit that autobatch buffer using the previously discussed approach, attempt to advance the epoch to become the epoch selecting the autobatch buffer just committed, and if this operation succeeds, commit the previous buffer. After performing this deferred buffer commit, the process can check the condition in case additional threads filled new thread request entries that caused a new deferral commit to be necessary.

There can be several methods employed for how a server can notify the completion of work entries. In some aspects, where the requests are reads and writes of data, the work entries can specify a memory buffer where the data will be read to or written from in the work entry. There can be a status field per autobatch buffer. The status field can be set to a pending state. When the server process has completed processing the work entry, it can set the status field to a completion state or an error code (in case there was an error), thus notifying the requesting thread of the completion of the work and any errors associated with the command. When the requesting thread observes a change in the status field it can reset the status field to a pending state and execute the release autobatch buffer routine. For example, the release can be decrementing the count kept for each active autobatch buffer. The benefit can be that each requesting thread knows exactly where the thread will be notified for the completion of its work entry. This can be compared to the traditional queue pairs where the requesting threads have to poll on and manage the completion queue to find the completion of its work entry.

Turning now to the figures, FIG. 1 is an illustration of a diagram of an example chart 100 showing the throughput of various processes. Chart 100 demonstrates a sample processing of threads and the resulting throughputs. Chart 100 has an x-axis 105 showing the number of threads and a y-axis 106 showing the throughput in millions of inputs/outputs per second (MIOPS).

Line 110 (diamond markers) demonstrates the throughput using a conventional global queue process, where the streaming multiprocessors (SMs) share the same queue. Line 115 (triangle markers) demonstrates using a conventional global queue process utilizing SM queues, where each SM queue is a queue in a processor (e.g., CPU or GPU). Line 120 (square markers) demonstrates using the disclosed autobatch buffer processes utilizing a global queue. Line 125 (x markers) demonstrates using the disclosed autobatch buffer processes utilizing SM queues. This demonstrates that using autobatch buffers can improve throughput, and using autobatch buffers using SM queues can improve the consistency of the throughput, such as using method 300 of FIG. 3.

FIG. 2 is an illustration of diagrams of example autobatch buffer systems 200. Autobatch buffer systems 200 shows a sample of the types of systems that can utilize the autobatch buffer processes disclosed herein. System 210 demonstrates an autobatch buffer process between two processors, of various types. System 220 demonstrates an autobatch buffer process between a GPU and a storage system. System 230 demonstrates an autobatch buffer process between a CPU and a storage system. System 240 demonstrates an autobatch buffer process between a GPU and a GPU. System 250 demonstrates an autobatch buffer process between a GPU and a NIC.

FIG. 3 is an illustration of a flow diagram of an example method 300 for utilizing batch processes. Method 300 can be performed on a computing system, for example, autobatch buffer system 400 of FIG. 4 or autobatch buffer controller 500 of FIG. 5. The computing system can be one or more processors in various combinations (e.g., CPUs, GPUs, SIMDs or other types of processors), a data center, a cloud environment, a server, a laptop, a mobile device, a smartphone, a PDA, or other computing system capable of receiving the thread requests, and capable of executing threads in parallel. Method 300 can use a global thread submission process or a SM thread submission process. Method 300 can be encapsulated in software code or in hardware, for example, an application, code library, code module, dynamic link library, module, function, RAM, ROM module, and other software and hardware implementations. The software can be stored in a file, database, or other computing system storage mechanism. Method 300 can be partially implemented in software and partially in hardware. Method 300 can perform the steps for the described processes, for example, batching multiple thread requests.

Method 300 starts at a step 305 and proceeds to a step 310. In a step 310, more than one thread request can be received at an autobatch buffer processing system. In a step 315, each received thread request can be stored in an autobatch buffer. If an autobatch buffer is full, e.g., an overflow condition, another autobatch buffer can be designated the active autobatch buffer to receive the thread request.

In a step 320, an autobatch buffer can be submitted for execution of the component thread requests. One thread request can be designated as the control thread and will complete after the other threads have completed. In some aspects, the control thread can be the first thread request inserted into the autobatch buffer. In some aspects, the control thread can be the last thread request inserted into the autobatch buffer, which allows the other non-control threads to execute 2-4 atomic operations while the control thread can execute the number of atomic operations needed to monitor the autobatch buffer completion status. This number can exceed 4 atomic operations.

In a step 325, the autobatch buffer can be retired. The autobatch buffer can be retired at a time the control thread indicates. When retired, the buffer.in-counter and buffer.out-counter can be set to zero indicating that the autobatch buffering has completed. The retired autobatch buffer can be reused for the next set of thread requests. Method 300 ends at a step 395.

FIG. 4 is an illustration of a block diagram of an example autobatch buffer system 400. Autobatch buffer system 400 can be implemented in one or more computing systems or one or more processors. In some aspects, autobatch buffer system 400 can be implemented using an autobatch buffer controller such as autobatch buffer controller 500 of FIG. 5. Autobatch buffer system 400 can implement one or more aspects of this disclosure, such as method 300 of FIG. 3.

Autobatch buffer system 400, or a portion thereof, can be implemented as an application, a code library, a dynamic link library, a function, a module, a header file, other software implementation, or combinations thereof. In some aspects, autobatch buffer system 400 can be implemented in hardware, such as a ROM, a graphics processing unit, or other hardware implementation. In some aspects, autobatch buffer system 400 can be implemented partially as a software application and partially as a hardware implementation. Autobatch buffer system 400 is a functional view of the disclosed processes and an implementation can combine or separate the described functions in one or more software or hardware systems.

Autobatch buffer system 400 includes a data transceiver 410, an autobatch buffer processor 420, and a result transceiver 430. The results, e.g., the batched thread requests from autobatch buffer processor 420, can be communicated to a data receiver, such as one or more of a processing system 460 (one or more combinations of processors or processing cores), one or more CPUs 462, one or more GPUs 464, or one or more storage devices 466. Processing system 460, CPUs 462, GPUs 464, and storage devices 466 are the functional systems as previously shown as systems 210, 220, 230, 240, or 250 of FIG. 2. The results can be used to execute the thread requests and perform the operations as directed by the instructions within the thread request.

Data transceiver 410 can receive the thread requests, as well as input parameters including operational parameters, such as the specified autobatch buffer size parameter, epoch time and range parameters, or other operational or control parameters or instructions. For example, the autobatch buffer size parameter can be in an inclusive range of 64 to 8,000. In some aspects, data transceiver 410 can be part of autobatch buffer processor 420.

Result transceiver 430 can communicate one or more results, to one or more data receivers, such as processing systems 460, CPUs 462, GPUs 464, storage devices 466, NICs, or other related systems, whether located proximate result transceiver 430 or distant from result transceiver 430. Data transceiver 410, autobatch buffer processor 420, and result transceiver 430 can include, conventional interfaces configured for transmitting and receiving data. Data transceiver 410, autobatch buffer processor 420, or result transceiver 430 can be implemented as software components, for example, a virtual processor environment, as hardware, for example, circuits of an integrated circuit, or combinations of software and hardware components and functionality. The functionality described for these components remains intact regardless of how the functionality is implemented.

Autobatch buffer processor 420 (e.g., one or more processors such as processor 530 of FIG. 5) can implement the analysis and algorithms as described herein utilizing the input parameters to manage received processing threads using autobatch buffers and the disclosed control structures. The input parameters can be a specified autobatch buffer size parameter, an epoch time, a range parameter, or other operational parameters. Autobatch buffer processor 420 can be one or more of a multicore processor, a multiprocessor system, or a streaming multiprocessor. For example, autobatch buffer processor 420 can determine an active autobatch buffer, handle an autobatch buffer overflow condition, set the size of an autobatch buffer, store received thread requests, submit an autobatch buffer, commit an autobatch buffer, and cleanup, e.g., retire, an autobatch buffer.

A memory or data storage system of autobatch buffer processor 420 (such as a core cache, L1 cache, L2 cache, or other memory systems) can be configured to store the processes and algorithms for directing the operation of autobatch buffer processor 420. A thread management system 425 can be present to store the threads in the appropriate buffers and provide the memory storage of the buffer parameters, where there can be one or more buffers. Autobatch buffer processor 420 can also include a processor that is configured to operate according to the analysis operations and algorithms disclosed herein, and an interface to communicate (transmit and receive) data.

FIG. 5 is an illustration of a block diagram of an example of an autobatch buffer controller 500 according to the principles of the disclosure. Autobatch buffer controller 500 can be stored on one computer or on multiple computers. The various components of autobatch buffer controller 500 can communicate via wireless or wired conventional connections. A portion or a whole of autobatch buffer controller 500 can be located at one or more locations. In some aspects, autobatch buffer controller 500 can be part of another system (e.g., processor, core, server, or other systems), and can be integrated in one device, such as a part of a processing system. Autobatch buffer controller 500 represents a demonstration of the functionality employed for the disclosure, and implementations can use a variety of devices, for example, circuits of a processor, dedicated processors, virtual systems, servers, other computing or processing systems, be in software or hardware, or various combinations thereof.

Autobatch buffer controller 500 can be configured to perform the various functions disclosed herein including receiving input parameters and generating results from execution of the methods and processes described herein, such as determining an autobatch buffer size parameter, determining an active autobatch buffer, storing received thread requests, submitting autobatch buffers, and committing and cleaning up autobatch buffers. Autobatch buffer controller 500 includes a communications interface 510, a memory 520, and a processor 530.

Communications interface 510 is configured to transmit and receive data. For example, communications interface 510 can receive the input parameters and thread requests.

Communications interface 510 can transmit the results or interim outputs. In some aspects, communications interface 510 can transmit a status, such as a success or failure indicator of autobatch buffer controller 500 regarding receiving the various inputs, transmitting the generated results, or producing the results.

In some aspects, processor 530 can perform the operations as described by autobatch buffer processor 420. Communications interface 510 can communicate via communication systems used in the industry. For example, wireless or wired protocols can be used. Communication interface 510 is capable of performing the operations as described for data transceiver 410 and result transceiver 430 of FIG. 4.

Memory 520 can be configured to store a series of operating instructions that direct the operation of processor 530 when initiated, including the code representing the algorithms for determining the operation of the autobatch buffers. Memory 520 is a non-transitory computer-readable medium. Multiple types of memory can be used for the data storage systems and memory 520 can be distributed.

Processor 530 can be one or more processors. Processor 530 can be a combination of processor types, such as a CPU, a GPU, SIMD, or other processor types. Processor 530 can be configured to produce the results, one or more interim outputs, and statuses utilizing the received inputs. Processor 530 can determine the results using parallel processing. Processor 530 can be an integrated circuit. In some aspects, processor 530, communications interface 510, memory 520, or various combinations thereof, can be an integrated circuit. Processor 530 can be configured to direct the operation of autobatch buffer controller 500. Processor 530 includes the logic to communicate with communications interface 510 and memory 520, and perform the functions described herein. Processor 530 is capable of performing or directing the operations as described by autobatch buffer processor 420 of FIG. 4.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein. The data storage media can be part of or associated with the digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user and some components can be located in a cloud environment or data center.

The GPUs can be embodied on one semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on one chip. Configured or configured to means, for example, designed, constructed, or programmed, with the necessary logic and/or features for performing a task or tasks.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Each one of the aspects noted in the Summary can have one or more of the features of the dependent claims in combination. Element 1: wherein the autobatch buffer is sized to hold a number of thread requests equal to an autobatch buffer size parameter. Element 2: wherein the autobatch buffer size parameter is in an inclusive range of 64 to 8,000. Element 3: wherein the autobatch buffer is a first autobatch buffer, and one of the first autobatch buffer or a second autobatch buffer is designated as an active autobatch buffer, and the storing of the set of thread requests is done in the active autobatch buffer. Element 4: wherein when the active autobatch buffer indicates an overflow condition, the storing of the set of thread requests is retried. Element 5: further comprising switching the active autobatch buffer to another autobatch buffer within the epoch when the active autobatch buffer indicates an overflow condition. Element 6: further comprising designating the another autobatch buffer as the active autobatch buffer when an in-counter and an out-counter of the another autobatch buffer is set to zero. Element 7: wherein the active autobatch buffer indicates an overflow condition and the storing of the set of thread requests is retried after the epoch is incremented to a subsequent epoch. Element 8: wherein the first autobatch buffer and the second autobatch buffer are actively processing the set of thread requests. Element 9: wherein the processing system is one or more of a multicore processor, a multiprocessor system, or a streaming multiprocessor. Element 10: wherein one operation in the set of atomic operations is to increase an in-counter indicating a number of thread requests started within the autobatch buffer. Element 11: wherein one operation in the set of atomic operations is to increase an out-counter indicating a number of thread requests completed within the autobatch buffer. Element 12: wherein one operation in the set of atomic operations is to increase a resend counter indicating a number of resent requests by the autobatch buffer. Element 13: wherein an increment to the epoch indicates a new autobatch buffer to be used for subsequent received thread requests. Element 14: wherein the control thread is a first thread request inserted into the autobatch buffer. Element 15: wherein the control thread is a last thread request inserted into the autobatch buffer. Element 16: wherein the control thread is the thread request that completes first among thread requests stored in the autobatch buffer. Element 17: wherein the batch process is encapsulated in a header file of a code module. Element 18: wherein the batch process is encapsulated in a ROM module or a code module of a library. Element 19: wherein a server process sets a status field to a completion state or an error code when the server process has completed processing the autobatch buffer, there is one status field per autobatch buffer, and the control thread reads the status field to process the error code or execute a release autobatch buffer routine. Element 20: wherein one of the thread requests in each of the linear autobatch buffers is designated a control thread and remaining ones of the thread requests are non-control thread requests. Element 21: wherein the non-control thread requests execute a set of atomic operations. Element 22: wherein the parallel processing is performed using one or more cores, one or more processors, or one or more streaming processors. Element 23: wherein the one or more processors are one or more of one or more central processing units (CPUs), one or more graphics processing units (GPUs), one or more single instruction multiple data (SIMD) processors, or one or more streaming multiprocessors (SM).

What is claimed is:

1. A method to batch process more than one thread request as a set of thread requests, comprising:
receiving the set of thread requests within an epoch, wherein the set of thread requests comprise instructions to a processing system to execute code;
storing the set of thread requests in an autobatch buffer, wherein the autobatch buffer is a linear buffer;
submitting contents of the autobatch buffer in one operation, wherein one thread request in the autobatch buffer is designated a control thread, and the set of thread requests in the autobatch buffer execute a set of atomic operations; and
retiring the autobatch buffer at a time the control thread indicates.

2. The method as recited in claim 1, wherein the autobatch buffer is sized to hold a number of thread requests equal to an autobatch buffer size parameter.

3. The method as recited in claim 2, wherein the autobatch buffer size parameter is in an inclusive range of 64 to 8,000.

4. The method as recited in claim 1, wherein the autobatch buffer is a first autobatch buffer, and one of the first autobatch buffer or a second autobatch buffer is designated as an active autobatch buffer, and the storing of the set of thread requests is done in the active autobatch buffer.

5. The method as recited in claim 4, wherein when the active autobatch buffer indicates an overflow condition, the storing of the set of thread requests is retried.

6. The method as recited in claim 4, further comprising:
switching the active autobatch buffer to another autobatch buffer within the epoch when the active autobatch buffer indicates an overflow condition.

7. The method as recited in claim 6, further comprising:
designating the another autobatch buffer as the active autobatch buffer when an in-counter and an out-counter of the another autobatch buffer is set to zero.

8. The method as recited in claim 4, wherein the active autobatch buffer indicates an overflow condition and the storing of the set of thread requests is retried after the epoch is incremented to a subsequent epoch.

9. The method as recited in claim 4, wherein the first autobatch buffer and the second autobatch buffer are actively processing the set of thread requests.

10. The method as recited in claim 1, wherein the processing system is one or more of a multicore processor, a multiprocessor system, or a streaming multiprocessor.

11. The method as recited in claim 1, wherein one operation in the set of atomic operations is to increase an in-counter indicating a number of thread requests started within the autobatch buffer.

12. The method as recited in claim 1, wherein one operation in the set of atomic operations is to increase an out-counter indicating a number of thread requests completed within the autobatch buffer.

13. The method as recited in claim 1, wherein one operation in the set of atomic operations is to increase a resend counter indicating a number of resent requests by the autobatch buffer.

14. The method as recited in claim 1, wherein an increment to the epoch indicates a new autobatch buffer to be used for subsequent received thread requests.

15. The method as recited in claim 1, wherein the control thread is a first thread request inserted into the autobatch buffer.

16. The method as recited in claim 1, wherein the control thread is a last thread request inserted into the autobatch buffer.

17. The method as recited in claim 1, wherein the control thread is the thread request that completes first among thread requests stored in the autobatch buffer.

18. The method as recited in claim 1, wherein the batch process is encapsulated in a header file of a code module.

19. The method as recited in claim 1, wherein the batch process is encapsulated in a ROM module or a code module of a library.

20. The method as recited in claim 1, wherein a server process sets a status field to a completion state or an error code when the server process has completed processing the autobatch buffer, there is one status field per autobatch buffer, and the control thread reads the status field to process the error code or execute a release autobatch buffer routine.

21. A system, comprising:
a receiver, operational to receive thread requests, wherein the thread requests are requests to a processing system to execute code;
one or more linear autobatch buffers operational to store the thread requests; and
one or more processors, operational to execute the thread requests using parallel processing, wherein each of the linear autobatch buffers submits its thread requests in one operation and each of the linear autobatch buffers are retired according to a control thread within each respective linear autobatch buffers.

22. The system as recited in claim 21, wherein one of the thread requests in each of the linear autobatch buffers is designated a control thread and remaining ones of the thread requests are non-control thread requests.

23. The system as recited in claim 22, wherein the non-control thread requests execute a set of atomic operations.

24. The system as recited in claim 21, wherein the parallel processing is performed using one or more cores, one or more processors, or one or more streaming processors.

25. The system as recited in claim 21, wherein the one or more processors are one or more of one or more central processing units (CPUs), one or more graphics processing units (GPUs), one or more single instruction multiple data (SIMD) processors, or one or more streaming multiprocessors (SM).

26. A computer program product having a series of operating instructions stored on a non-transitory computer-readable medium that directs a data processing apparatus when executed thereby to perform operations to batch process more than one thread request as a set of thread requests, the operations comprising:
receiving the set of thread requests within an epoch, wherein the set of thread requests comprise instructions to a processing system to execute code;
storing the set of thread requests in an autobatch buffer, wherein the autobatch buffer is a linear buffer;
submitting contents of the autobatch buffer in one operation, wherein one thread request in the autobatch buffer is designated a control thread, and the set of thread requests in the autobatch buffer execute a set of atomic operations; and
retiring the autobatch buffer at a time the control thread indicates.
